(19) United States
(12) Patent Application Publication
(10) Pub. No.: US 2008/0066015 A1
(43) Pub. Date: Mar. 13, 2008

(54) VISUAL DISPLAY OF AUTOMATED TELEPHONE SYSTEM MENUS

(76) Inventor: Thomas Tyrone Blankenhorn, Petaluma, CA (US)

Correspondence Address: Thomas Blankenhorn, 810 Lenella Lane, Grants Pass, OR, 97526, US

(21) Appl. No.: 11/467,548

(22) Filed: Aug. 26, 2006

(51) Int. Cl. G06F 3/048

(52) U.S. Cl. 715/853

(57) ABSTRACT

An efficient method for dealing with automated telephone system menus is provided herein. The method includes a new signaling from origination of the phone menu system to allow for visual display of the phone menu and the means by which the end-user can view the phone menu choices.

### BACKGROUND OF THE INVENTION

1. Field of the Invention

This invention relates to automated telephone menu systems, otherwise known as automatic call distribution (ACD).

2. Description of the Related Art

Automated telephone systems presently operate by the sending of audible signals in the form of words to which a telephone end-user listens, often times with painstaking patience. Upon hearing the various choices, the end-user makes a decision by pressing a number or symbol on the keypad of the phone.

Shortcomings in this present mode include loss of productivity and unnecessary frustration to both end-users and to persons at the point of origination of the phone menu system. An end-user often experiences impatience in waiting to hear all the phone menu choices and through frustration, hastily selects a choice likely causing the call to be misrouted. When callers are routed to the wrong department, frustration may escalate with the caller. Recipients of such calls may begin feeling frustrated as it detracts from the function for which they are employed. This is a common situation for which there demands an innovation to reduce financial losses and perhaps more importantly, lessen frustration to all persons involved as a result of dealing with the present inefficient art of automated telephone menu systems.

### SUMMARY OF THE INVENTION

Automated telephone systems, wherein a caller connects to [ordinarily] a company or government office, presently operates by means of allowing a caller to choose among several audible choices in order to have the call routed to the desired department. This invention introduces a new concept wherein the automated system sends digital signals to be processed by telephone equipment for effecting a visual display of the phone menu choices for the end-user. By having a visual display on either the actual telephone device or on a stand-alone device, the end-user could then swiftly navigate through the automated phone menu in terms of seconds, and not minutes, as is sometimes the case with the present art.

### DESCRIPTION OF THE PREFERRED EMBODIMENTS

In order to satisfy legacy telephones, automated telephone menu systems would overlay concomitantly the present art of the audible words along with a digital signal effecting a visual display on a telephone or stand-alone device. An end-user could thus curtail listening to all the menu choices by choosing an option based on the immediate visual display of the choices.

The protocol of the telephone menu systems would have a universal set of instructions to enable compatibility with all telephonic devices having a means of translating the digital signals to a visual display.

The visual set of menu choices of the automated telephone menu system at the point of the end-user would be on the telephone itself. In the rudimentary stage of implementation, a stand-alone device to be attached in series would be made available to landline phones in much the same way that caller ID boxes were introduced while caller ID was being designed as an embedded complementary feature on telephones.

For present cell phones, to adopt the new art presented herein, the phone would need to be programmable by either the manufacturer or cell phone company to allow for the visual display of menu choices, otherwise cell phone manufacturers would have to incorporate the technology in future models.

In a favorable situation, the visual display would be seen in its entirety to enable the end-user to make a swift decision upon the various phone menu choices. Size limitations or design constraints are considered and thus a truncated display would enable functionality of this art provided a means to toggle through the choices are made available. This would apply to both actual telephone displays and to in-line stand-alone devices.

No drawings are needed as one versed in the field is aware of the general configuration of stand-alone caller ID boxes that were introduced upon inception of that particular technology. For this invention, immediate commercial implementation would utilize the general form of caller ID boxes as in-line devices for which end-users could see the phone menu choices. Additionally, envisioning a display of automated telephone menu options on a telephone requires no special mention to be reduced to a figure or drawing.

What is claimed is:

1. An improvement of automated telephone menu systems by which the system provides digital signals to telephone devices for the ultimate purpose of allowing end-users to visualize the phone menu choices.

2. The set of instructions within a telephone device that specifically converts digital signals emanating from automated telephone systems to drive a visual display on a telephone device. The telephone device can be a stand-alone device for the sole purpose of displaying the menu choices, a landline phone, cell phone, personal digital assistant (PDA) or any other electronic device capable of placing a phone call.

3. A visual display on telephones and stand-alone devices for enabling an end-user to see the choices of the automated phone menu. The display is broadly any form, and not limited to plasma or LCD, as the essence of this claim would pertain to any present or future technology enabling a visual display for said purpose. The display of the phone menu options can be viewed in its entirety, or truncated in the event of lack of space per size or design limitations.
